(19) United States
(12) Patent Application Publication
(10) Pub. No.: US 2016/0142570 A1
(43) Pub. Date: May 19, 2016

(54) RECORDING-MEDIUM TRANSPORTING AND READING APPARATUS

(71) Applicant: FUJI XEROX CO., LTD., Tokyo (JP)

(72) Inventors: Senggyu CHO, Kanagawa (JP); Seongwoo BAEK, Kanagawa (JP); Sangchun PARK, Kanagawa (JP); Yonsun CHAN, Kanagawa (JP); Youngsea PARK, Kanagawa (JP); Ken KOBAYASHI, Kanagawa (JP)

(73) Assignee: FUJI XEROX CO., LTD., Tokyo (JP)

(21) Appl. No.: 14/704,343

(22) Filed: May 5, 2015

(30) Foreign Application Priority Data
Nov. 14, 2014 (JP) 2014-231523

(51) Int. Cl. H04N 1/00

(52) U.S. Cl. CPC H04N 1/00588; H04N 1/00615; H04N 1/00591; H04N 2201/0081

(57) ABSTRACT

A recording-medium transporting and reading apparatus includes a reading member that has a reading portion for reading an image; a first transport-path forming member that faces the reading member and has a first surface which forms a transport path portion for a recording medium together with the reading member; a second transport-path forming member that forms transport path portions on the same side as the first transport-path forming member and has a second surface and a third surface which form the transport path portions on the upstream side and downstream side, respectively, of the first transport-path forming member in the recording-medium transport direction; an urging member that urges the first transport-path forming member toward the reading member; and a restricting portion that restricts the movement of the first transport-path forming member so that a predetermined distance is maintained between the reading member and the first transport-path forming member.

### CROSS-REFERENCE TO RELATED APPLICATIONS

This application is based on and claims priority under 35 USC 119 from Japanese Patent Application No. 2014-231523 filed Nov. 14, 2014.

### BACKGROUND

### Technical Field

The present invention relates to a recording-medium transporting and reading apparatus.

### SUMMARY

According to a first aspect of the invention, there is provided a recording-medium transporting and reading apparatus including a reading member that has a reading portion for reading an image; a first transport-path forming member that faces the reading member and has a first surface which forms a transport path portion for a recording medium together with the reading member; a second transport-path forming member that forms transport path portions on the same side as the first transport-path forming member and has a second surface which forms the transport path portion on the upstream side of the first transport-path forming member in a recording-medium transport direction and a third surface which forms the transport path portion on the downstream side of the first transport-path forming member in the recording-medium transport direction; an urging member that urges the first transport-path forming member toward the reading member in such a manner that the first transport-path forming member is movable relative to the second transport-path forming member; and a restricting portion that restricts the movement of the first transport-path forming member so that a predetermined distance is maintained between the reading member and the first transport-path forming member.

### BRIEF DESCRIPTION OF THE DRAWINGS

An exemplary embodiment of the present invention will be described in detail based on the following figures, wherein:

FIG. 1 is a schematic view showing the configuration of a recording-medium transporting and reading apparatus according to an exemplary embodiment of the present invention;

FIG. 2 is a diagram for explaining the inside structure of a contact image sensor (CIS) according to the exemplary embodiment of the present invention;

FIG. 3 shows the CIS according to the exemplary embodiment of the present invention, as viewed from a transport path;

FIG. 4 is a diagram for explaining the configuration of the transport path in the vicinity of the CIS;

FIG. 5 shows a transport-path forming member according to the exemplary embodiment of the present invention;

FIG. 6 is an enlarged view of the relevant part in FIG. 4;

FIG. 7 is a diagram showing the configuration of the CIS and its vicinity according to the exemplary embodiment of the present invention, showing a state in which the transport-path forming member is closed; and

FIG. 8 is a diagram showing the configuration of the CIS and its vicinity according to the exemplary embodiment of the present invention, showing a state in which the transport-path forming member is open.

### DETAILED DESCRIPTION

Next, an exemplary embodiment of the present invention will be described with reference to the drawings.

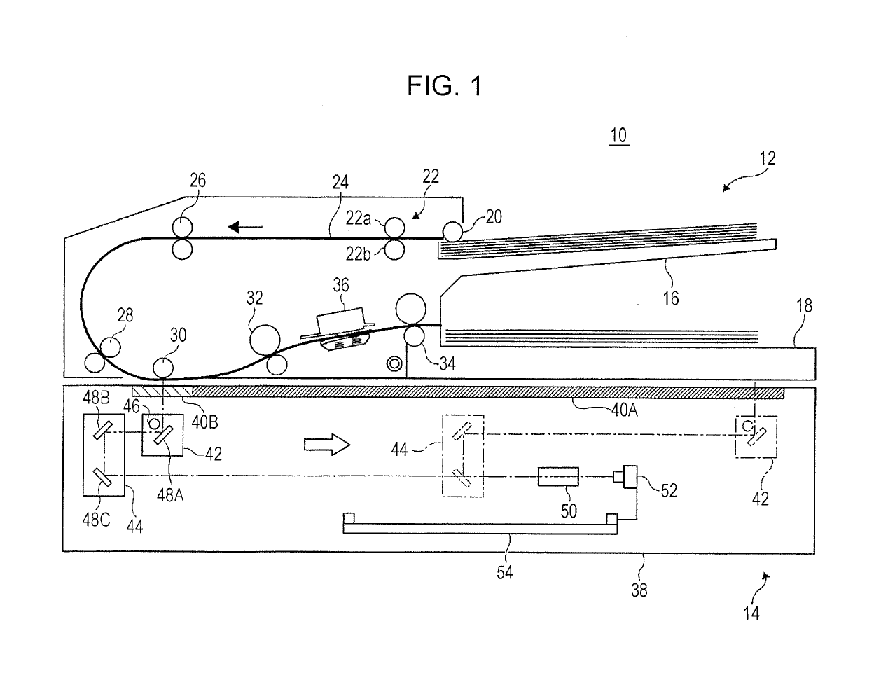

FIG. 1 shows the overall configuration of a recording-medium transporting and reading apparatus 10 according to this exemplary embodiment. This recording-medium transporting and reading apparatus 10 includes a recording-medium feeding unit 12 that successively transports recording media from a stack of recording media, and a scanner unit 14 that scans first surfaces (front surfaces) of the recording media to read images thereon.

The recording-medium feeding unit 12 includes a recording-medium storage portion 16 that carries a stack of recording media, and an output-recoding-media storage portion 18 that is provided below the recording-medium storage portion 16 and carries the recording media that have been read. The recording-medium feeding unit 12 also includes a pickup roller 20 that picks up and transports recording media in the recording-medium storage portion 16. Furthermore, a separating mechanism 22 that separates the recording media into individual sheets is provided on the downstream side of the pickup roller 20 in the recording-medium transport direction. The separating mechanism 22 includes a feed roller 22a that transports the recording media fed by the pickup roller 20 to a further downstream side, and a retard roller 22b that separates the recording media fed by the pickup roller 20 into individual sheets. Pre-register rollers 26, register rollers 28, a platen roller 30, out rollers 32, and discharge rollers 34 are provided in a transport path 24, along which the recording medium is transported, in this order from the upstream side in the recording-medium transport direction. The pre-register rollers 26 transport a separated recording medium toward the downstream rollers and forms a loop of the recording medium. The register rollers 28 feed the recording medium to a recording-medium reading portion (described below) while adjusting the registration by stopping and restarting the rotation at certain timing. The platen roller 30 supports the transportation of the recording medium that is being read by the scanner unit 14. The out rollers 32 transport the recording medium after being read by the scanner unit 14 to a further downstream side. The discharge rollers 34 further transport the recording medium after reading and output the recording medium onto the output-recoding-medium storage portion 18.

The recording-medium feeding unit 12 also includes a contact image sensor (CIS) 36 that reads an image on a second surface (back surface) of the recording medium. The CIS 36 is provided between the out rollers 32 and the discharge rollers 34.

The scanner unit 14 supports, by an apparatus frame 38, the recording-medium feeding unit 12 in such a manner that the recording-medium feeding unit 12 may be opened and closed and reads an image on the recording medium transported by the recording-medium feeding unit 12. The scanner unit 14 includes the apparatus frame 38 that constitutes a housing, a first platen glass 40A that supports a stationary recording medium to be scanned for image reading, and a second platen glass 40B that has an opening through which light for reading the recording medium transported by the recording-medium feeding unit 12 is radiated.

The scanner unit 14 also includes a full-rate carriage 42 that stays below the second platen glass 40B or scans across the first platen glass 40A to read an image, and a half-rate carriage 44 that sends light obtained from the full-rate carriage 42 to an image-forming portion. The full-rate carriage 42 includes an illumination lamp 46 that radiates light to the recording medium, and a first mirror 48A that receives light reflected from the recording medium. Furthermore, the half-rate carriage 44 includes a second mirror 48B and a third mirror 48C that send the light from the first mirror 48A to the image-forming portion. The scanner unit 14 also includes an image-forming lens 50 and a charge coupled device (CCD) image sensor 52. The image-forming lens 50 optically reduces an optical image of obtained from the third mirror 48C. The CCD image sensor 52 photoelectrically converts the optical image formed by the image-forming lens 50. That is, the scanner unit 14 forms an image on the CCD image sensor 52, using a so-called reduction optical system. The scanner unit 14 also includes a control and image-processing unit 54. The control and image-processing unit 54 performs predetermined processing on image data of the front and back surfaces of the recording medium that are inputted from the CCD image sensor 52 and the CIS 36 (described in detail below). The control and image-processing unit 54 controls the movements of the respective parts during a reading operation of the recording-medium transporting and reading apparatus 10.

In a fixed reading mode where an image on a recording medium placed on the first platen glass 40A is to be read, the full-rate carriage 42 and the half-rate carriage 44 move in a scanning direction (arrow direction) in a ratio of 2:1. At this time, light from the illumination lamp 46 of the full-rate carriage 42 is radiated onto a read surface of the recording medium. Then, light reflected from the recording medium is reflected by the first mirror 48A, the second mirror 48B, and the third mirror 48C and is guided to the image-forming lens 50. The light guided to the image-forming lens 50 is formed into an image on a light-receiving surface of the CCD image sensor 52. The CCD image sensor 52 is a one-dimensional sensor and processes one line at a time. The full-rate carriage 42 and the half-rate carriage 44 move in a line direction (sub-scanning direction) and read the next line of the recording medium. By performing this reading process over the entire recording medium, reading of one page of the recording medium is completed.

The second platen glass 40B is formed of, for example, a long transparent glass plate. In a transporting reading mode where an image of the recording medium that is being transported by the recording-medium feeding unit 12 is to be read, the recording medium that is transported passes above the second platen glass 40B. At this time, the full-rate carriage 42 and the half-rate carriage 44 stay at positions where they are illustrated with solid lines in FIG. 1. Light reflected from the first line of the recording medium that has passed the platen roller 30 of the recording-medium feeding unit 12 is reflected by the first mirror 48A, the second mirror 48B, and the third mirror 48C and is formed into an image by the image-forming lens 50, and the CCD image sensor 52 reads this image. That is, after one line in the first scanning direction is processed at a time by the CCD image sensor 52, which is a one-dimensional sensor, the next one line, in the first scanning direction, of the recording medium that is transported by the recording-medium feeding unit 12 is read. When the trailing end of the recording medium has passed a reading position of the second platen glass 40B after the leading end thereof reached the reading position of the second platen glass 40B, reading of one page of the recording medium in the sub-scanning direction is completed.

In this exemplary embodiment, it is possible to read a second surface of the recording medium with the CIS 36 while the recording medium is transported for the CCD image sensor 52 to read a first surface thereof through the second platen glass 40B, with the full-rate carriage 42 and the half-rate carriage 44 being stopped. That is, images on the front and back surfaces of the recording medium may be read by the CCD image sensor 52 and the CIS 36 in one transportation of the recording medium through the transport path 24. In this exemplary embodiment, the reading position where the CIS 36 reads the second surface of the recording medium is located on the downstream side, in the recording-medium transport direction, of the reading position where the CCD image sensor 52 reads the first surface of the recording medium.

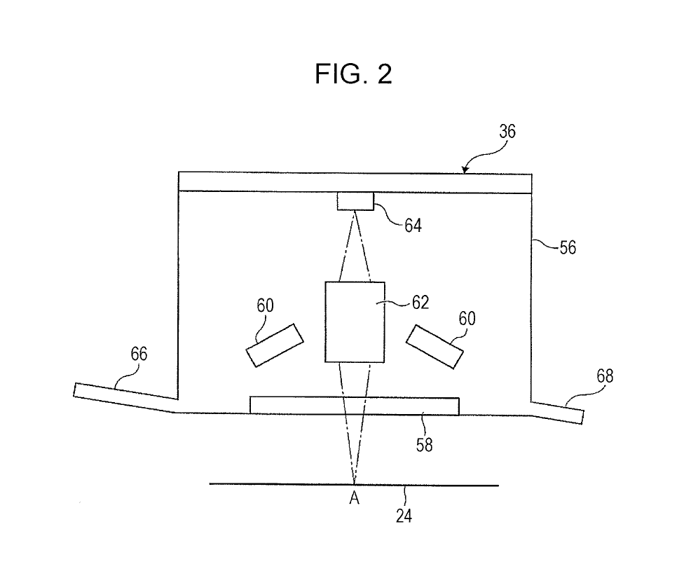

FIG. 2 is a diagram for explaining the inside structure of the CIS 36. The CIS 36, which serves as a reading member, is provided between the out rollers 32 and the discharge rollers 34, as shown in FIG. 1. One side (the first surface) of the recording medium is pressed against the second platen glass 40B, and the image on the first surface is read by the CCD image sensor 52. Meanwhile, the CIS 36 reads the image on the other side (the second surface) of the recording medium from the other side of the transport path 24. The CIS 36 includes a housing 56, a glass plate 58, light-emitting diode (LED) arrays 60, a rod lens array 62, and a line sensor 64. The glass plate 58 is fitted to an opening provided in a surface of the housing 56 facing the transport path 24. The LED arrays 60 radiate light onto the second surface of the recording medium through the glass plate 58. The rod lens array 62 collects reflected light of the light emitted from the LED arrays 60 at a reading position A. The line sensor 64 reads the light focused by the rod lens array 62. Examples of the line sensor 64 include a CCD, a complementary metal-oxide semiconductor (CMOS) sensor, and a contact sensor. The line sensor 64 reads images with the actual width (e.g., 297 mm, which is the longitudinal length of an A4-size sheet). That is, the CIS 36 captures an image not by using a reduction optical system, but by using a so-called 1.0× magnification optical system that employs the rod lens array 62 and the line sensor 64.

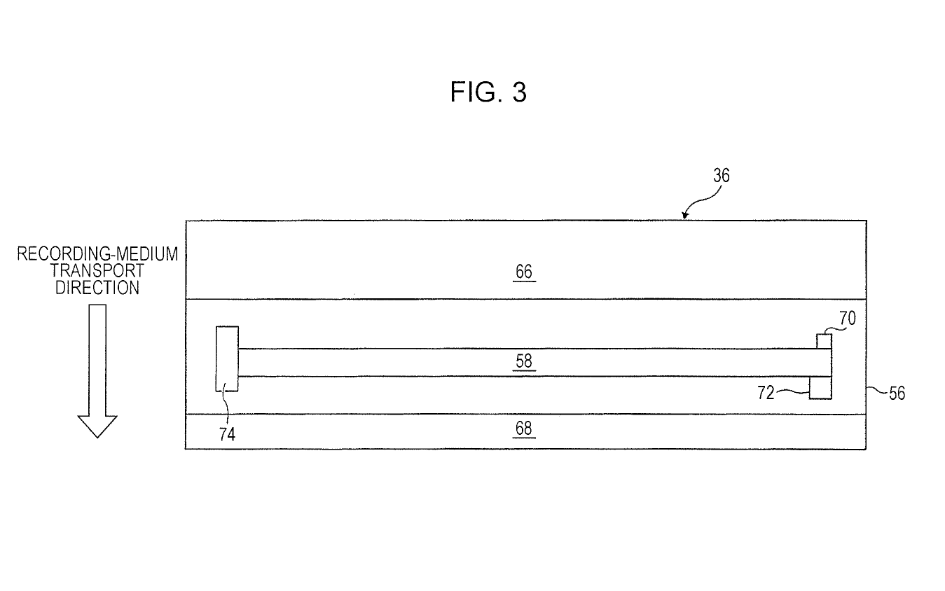

FIG. 3 shows the CIS 36, as viewed from the transport path 24.

The housing 56 of the CIS 36 has, for example, a rectangular parallelepiped shape and has a first guide member 66 and a second guide member 68 that are provided on a surface facing the transport path 24 and project to the upstream side and downstream side, respectively, in the recording-medium transport direction.

The glass plate 58 fitted to the surface of the housing 56 facing the transport path 24 has, at one end, a first restricting portion 70 and a second restricting portion 72 projecting toward the transport path 24 and has a third restricting portion 74 at the other end in the longitudinal direction.

The first restricting portion 70 is provided on the upstream side of the glass plate 58, and the second restricting portion 72 is provided on the downstream side of the first restricting portion 70 in the recording-medium transport direction, with the glass plate 58 therebetween. The third restricting portion 74 is provided at the other end of the glass plate 58 in the longitudinal direction.

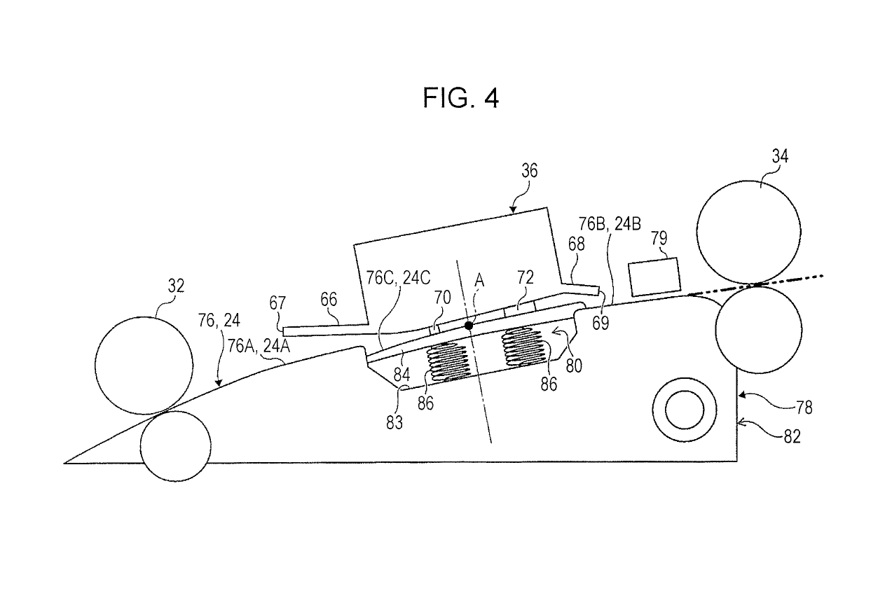

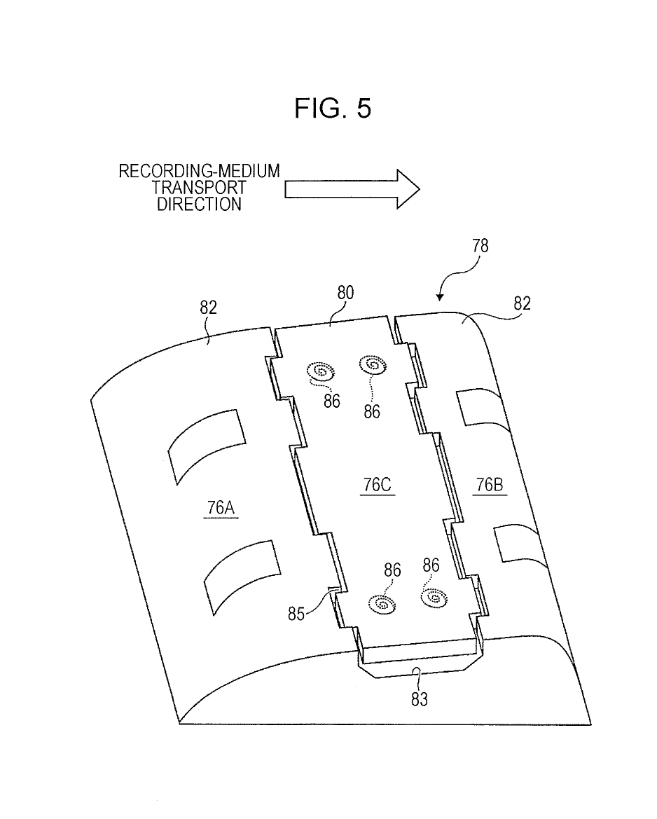

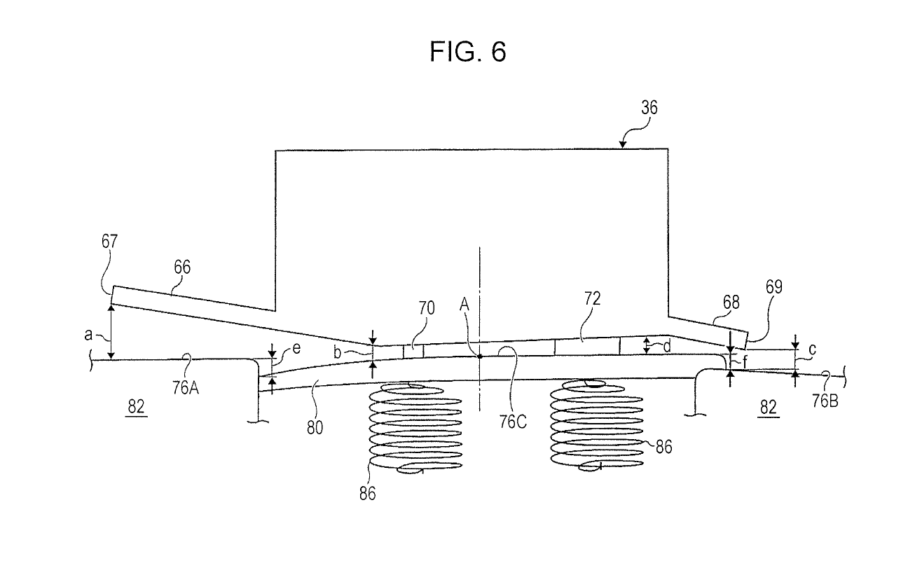

FIG. 4 is a diagram for explaining the configuration of the transport path 24 in the vicinity of the CIS 36, and FIG. 5 is a perspective view of a transport-path forming member 78 that forms part of the transport path 24, as viewed from the CIS 36. FIG. 6 is an enlarged view of the relevant part in FIG. 4.

A passage sensor 79 that detects passage of a recording medium is provided in the transport path 24, at a position between the CIS 36 and the discharge rollers 34. The recording medium, whose image information has been read by the CIS 36, is detected by the passage sensor 79 and is discharged outside by the discharge rollers 34.

The transport-path forming member 78 that has a transport path surface 76 constituting part of the transport path 24 is provided opposite the CIS 36. As shown in FIG. 4, the transport-path forming member 78 is formed in a flat, substantially trapezoidal shape, as viewed from the side, and the top surface thereof serves as the transport path surface 76.

The transport-path forming member 78 includes a first transport-path forming member 80 that forms part of the transport path surface 76 and faces the CIS 36, and a second transport-path forming member 82 that forms part of the transport path surface 76 and whose top surface is continuous with the upstream end and downstream end of the first transport-path forming member 80 in the recording-medium transport direction. The first transport-path forming member 80 is movable relative to the second transport-path forming member 82.

The first transport-path forming member 80 includes a support member 84 that has a first surface 76C facing the CIS 36 and constituting the transport path 24, and urging members 86, such as compression springs, that urge the support member 84 from a side opposite to the side facing the CIS 36. The thickness of the support member 84 increases from the upstream side to the downstream side in the recording-medium transport direction.

The second transport-path forming member 82 includes, in the top surface thereof, a second surface 76A that forms the transport path 24 and is located on the upstream side of the first surface 76C in the recording-medium transport direction, a recess 83 formed in substantially the middle, and a third surface 76B that forms the transport path 24 and is located on the downstream side of the first surface 76C in the recording-medium transport direction.

The support member 84 is fitted to the recess 83 in the second transport-path forming member 82 with the urging members 86 therebetween. Furthermore, the upstream end of the first transport-path forming member 80 in the recording-medium transport direction is joined to the second transport-path forming member 82 by a shaft 85 so as to be able to swing about the second transport-path forming member 82. The downstream end of the first transport-path forming member 80 in the recording-medium transport direction is fixed to the second transport-path forming member 82 by a snap member (not shown) so as not to come off therefrom.

More specifically, the second surface 76A, the first surface 76B, and the third surface 76C that form the transport path 24 are provided so as to be continuous with one another. The first transport-path forming member 80 is urged by the urging members 86 inside the recess 83 provided in the second transport-path forming member 82 and floats freely relative to the second transport-path forming member 82, thereby pushing a recording medium transported below the CIS 36 toward the CIS 36 from below (the transport-path forming member 78 side). The first transport-path forming member 80 is provided opposite the CIS 36, thereby minimizing the floating portion to reduce the size of the apparatus.

The first guide member 66 projects from the CIS 36 to the upstream side in the recording-medium transport direction and extends from an end portion 67 located above the second surface 76A to a position above the first surface 76C. The first guide member 66 guides the leading end of a recording medium in the recording-medium transport direction toward the first surface 76C, as the leading end advances from the end portion 67. That is, the first guide member 66 has a portion that is inclined upward toward the end portion 67 (away from the second surface 76A).

The second guide member 68 projects from the CIS 36 to the downstream side in the recording-medium transport direction and extends from a position above the first surface 76C to a position above the third surface 76B. The second guide member 68 guides the leading end of the recording medium in the recording-medium transport direction toward the third surface 76B, as the leading end advances toward an end portion 69. That is, the second guide member 68 has a portion that is inclined downward toward the end portion 69 (toward the third surface 76B).

A distance a between the second surface 76A and a surface of the end portion 67 of the first guide member 66 facing the second surface 76A is larger than a distance b between the first surface 76C and part of the surface of the CIS 36 facing the first surface 76C, the part being located on the upstream side of the reading position A in the recording-medium transport direction. Furthermore, a distance c between the third surface 76B and a surface of the end portion 69 of the second guide member 68 facing the third surface 76B is larger than a distance d between the first surface 76C and part of the surface of the CIS 36 facing the first surface 76C, the part being located on the downstream side of the reading position A in the recording-medium transport direction. Furthermore, the distance between the first surface 76C and the surface of the CIS 36 facing the first surface 76C increases from the upstream side of the reading position A toward the downstream side thereof.

Furthermore, at the boundary between the second surface 76A and the first surface 76C, a portion corresponding to the second surface 76A located on the upstream side in the recording-medium transport direction has the transport path 24 that is smaller, by a distance e, than that of a portion corresponding to the first surface 76C located on the downstream side in the recording-medium transport direction. The corner of the second surface 76A is rounded. Furthermore, at the boundary between the first surface 76C and the third surface 76B, a portion of the transport path 24 corresponding to the first surface 76C located on the upstream side in the recording-medium transport direction has a smaller area, by a distance f, than a portion of the transport path 24 corresponding to the third surface 76B located on the downstream side in the recording-medium transport direction. The corner of the first surface 76C is rounded. That is, at the boundaries between the second surface 76A and the first surface 76C and between the first surface 76C and the third surface 76B, the portions of the transport path 24 are formed continuously and arranged such that those on the upstream side have smaller areas than those on the downstream side in the recording-medium transport direction, whereby a jam of the recording medium occurring at the boundaries between the portions of the transport path 24 is prevented.

More specifically, the recording medium fed from the out rollers 32 is transported along a first transport path 24A (i.e., on the second surface 76A), is guided by the first guide member 66, and is transported along a third transport path 24C formed between the CIS 36 and the first surface 76C. During the transportation, the recording medium is urged toward the CIS 36 by the urging members 86. At this time, the movement of the first transport-path forming member 80 is restricted such that a predetermined distance is maintained between the CIS 36 and the recording medium by the first restricting portion 70, the second restricting portion 72, and the third restricting portion 74 to maintain the reading height constant. Then, the recording medium is guided by the second guide member 68, is transported along a second transport path 24B (i.e., above the third surface 76B), during which the passage sensor 79 detects passage of the recording medium, and is discharged from the discharge rollers 34. That is, the recording medium transported to the reading position A is urged toward the CIS 36 while being supported at three points to maintain the reading height (focal length) constant. Furthermore, a jam of recording media is prevented, enabling smooth transportation of the recording media.

The contact area between the second restricting portion 72 and the first surface 76C is larger than that between the first restricting portion 70 and the first surface 76C, and the contact area between the third restricting portion 74 and the first surface 76C is larger than that between the second restricting portion 72 and the first surface 76C. Because the CIS 36 is supported onto the first transport-path forming member 80 at three points, the CIS 36 does not rattle.

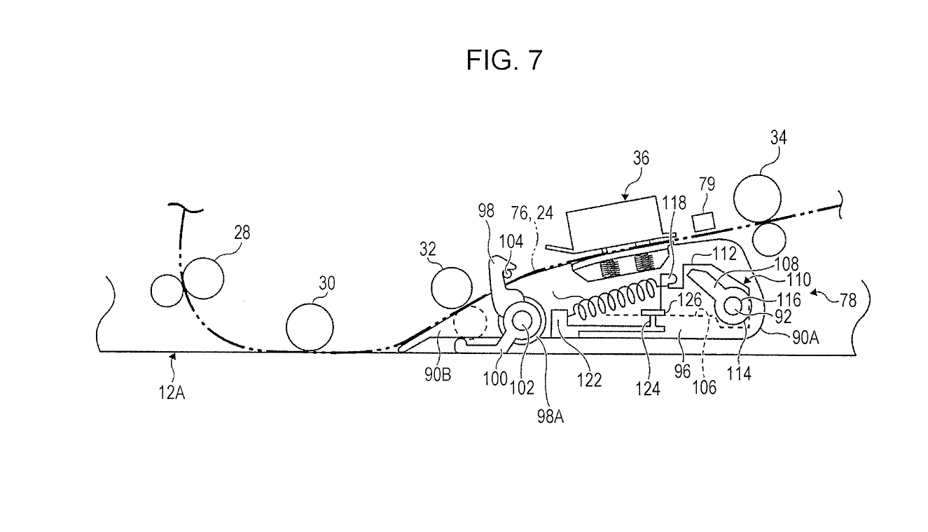

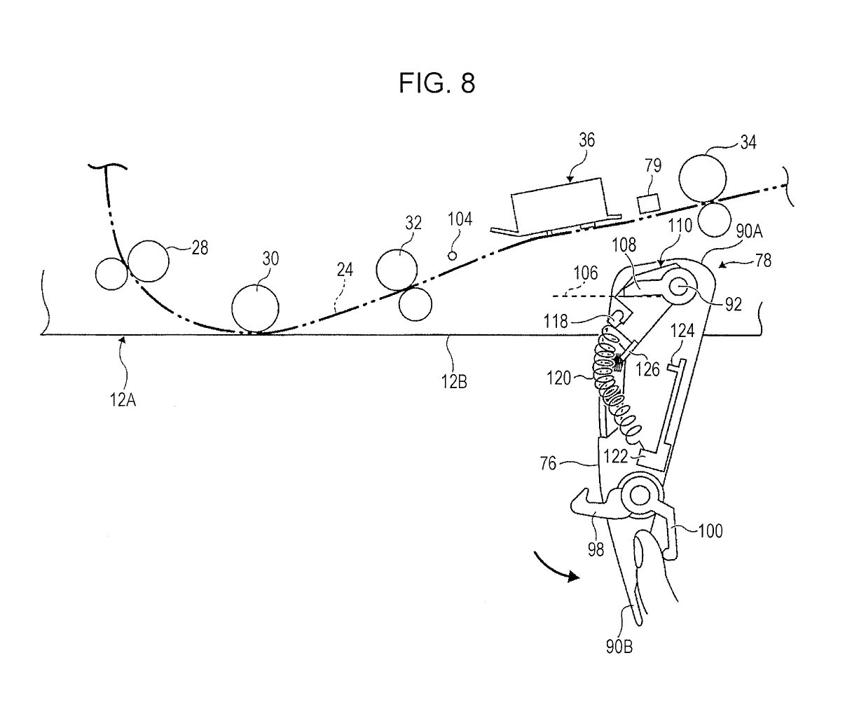

FIGS. 7 and 8 are diagrams showing the configuration of the CIS 36 and its vicinity according to the exemplary embodiment of the present invention, in which FIG. 7 shows a state where the transport path surface 76 is closed, and FIG. 8 shows a state where the transport path surface 76 is open.

The transport-path forming member 78 is rotatably supported at one end 90A on the downstream side in the recording-medium transport direction (i.e., on the side closer to the discharge rollers 34) by a body 12A of the recording-medium feeding unit 12 of the recording-medium transporting and reading apparatus. More specifically, a support shaft 92 provided on the body 12A passes through a through-hole (not shown) provided at the one end 90A of the transport-path forming member 78.

Hence, the other end 90B of the transport-path forming member 78 is supported so as to be able to swing about the support shaft 92 in the top-bottom direction, and when the other end 90B is moved (rotated) downward (i.e., in a direction away from the body 12A), part of the transport path 24 is opened.

Furthermore, a hook 98, serving as an example of an engaging member, and a lever 100, serving as an example of a manipulation member, are provided on a side wall 96, among the side walls of the transport-path forming member 78 provided in the rotation shaft direction, that is located on a side where the recording-medium feeding unit 12 is opened. The hook 98 and the lever 100 are attached, so as to be integrally rotated, to a rotation shaft 102 that is rotatably provided at the other end 90B of the transport-path forming member 78 located on the upstream side in the recording-medium transport direction.

More specifically, the hook 98 has a ring-shaped portion 98A at the lower end, which is securely fitted to the rotation shaft 102. The lever 100 has a ring-shaped portion 98A at the upper end, which is securely fitted to the rotation shaft 102. The hook 98 is constantly urged by an urging member, such as a torsion spring, in a direction (clockwise direction in FIG. 7) in which it is engaged with a catch portion 104, serving as an example of an engaged portion, provided on the body 12A.

Hence, the hook 98 is always engaged with the catch portion 104 when the transport path 24 (formed by the transport-path forming member 78) is closed, as shown in FIG. 7. When the lever 100 is rotated downward about the rotation shaft 102, the hook 98 is also rotated downward (i.e., counterclockwise direction in FIG. 7) and is disengaged from the catch portion 104. In this way, lock (a closed state of the transport path 24) of the transport-path forming member 78 is released.

Furthermore, the side wall 96 of the transport-path forming member 78 is provided with a link member 110, serving as an example of a support member, that has a stopper member 108 which comes into contact with a stopper portion 106 of the body 12A and restricts the movement of the other end 90B when the other end 90B of the transport-path forming member 78 is moved downward about the support shaft 92.

The link member 110 includes a base portion 112 that has a thin plate shape and the stopper member 108 that has a thick plate shape and is formed integrally with the base portion 112 in the thickness direction of the base portion 112. The link member 110 is rotatable relative to and coaxially with the transport-path forming member 78. More specifically, a ring-shaped portion 114 is formed at one end of the link member 110, and the ring-shaped portion 114 is fitted to a cylindrical boss 116 projecting from the vicinity of the through-hole in the transport-path forming member 78 so as to be capable of relative rotation.

The base portion 112 of the link member 110 has a hook-shaped attaching portion 118 at the other end, which is opposite from the end provided with the ring-shaped portion 114. One end of a coil spring 120, serving as an example of an urging member, is attached to the attaching portion 118, and the other end of the coil spring 120 is attached to an attaching portion 122 that is provided at the other end 90B of the side wall 96 of the transport-path forming member 78, i.e., at a position adjacent to the rotation shaft 102.

The coil spring 120 constantly urges a projecting portion 124 (described below) in a direction (clockwise direction in FIG. 7) in which it comes into contact with a stopper portion 126 (described below). The stopper portion 126, serving as an example of a restricting portion, that has a flat plate shape and projects in the thickness direction is formed immediately below the attaching portion 122 of the link member 110 (base portion 112).

The side wall 96 of the transport-path forming member 78 is provided with the projecting portion 124, serving as an example of a restricted portion, that is urged by the coil spring 120 in the clockwise direction in FIG. 7 and comes into contact with the stopper portion 126 has a rib shape that comes into contact (line contact) with the stopper portion 126 at right angles. The projecting portion 124 restricts relative rotation of the other end 90B of the transport-path forming member 78 in a direction toward the body 12A.

When a recording medium stops on the transport path surface (when a so-called jam occurs), the proximal end of the recording-medium feeding unit 12 is moved upward about a hinge at the distal end to expose the lever 100. By rotating the lever 100 downward, the hook 98 is disengaged from the catch portion 104 of the body 12A, allowing the other end 90B of the transport-path forming member 78 to move downward about the support shaft 92 at the one end 90A due to its own weight, as shown in FIG. 8. Thus, the transport path 24 (transport path surface) is opened.

Because the link member 110 is rotatable relative to the transport-path forming member 78, as shown in FIG. 8, the other end 90B of the transport-path forming member 78 moves downward (i.e., in the counterclockwise direction in FIG. 8), while resisting the urging force of the coil spring 120 (i.e., the coil spring 120 is stretched), with the stopper member 108 of the link member 110 being stopped by the stopper portion 106. At this time, the projecting portion 124 is separated from the stopper portion 126.

In this way, the other end 90B of the transport-path forming member 78 is opened, and the transport path 24 is widely opened. Thus, the recording medium that stops on the transport path surface may be easily removed. Hence, the ease of maintenance of the recording-medium feeding unit 12 is improved.

In the configuration like this, in which the other end 90B of the transport-path forming member 78 is opened, the reading surface of the CIS 36 may be exposed such that it is seen in a direction perpendicular to an open surface 12B of the body 12A that is opened by moving the transport-path forming member 78 downward. Accordingly, it is possible to easily perform cleaning of the reading surface (maintenance of the CIS 36), further improving the ease of maintenance of the recording-medium feeding unit 12.

As has been described above, the present invention is applicable to image forming apparatuses, such as copiers, facsimile machines, printers, etc.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording-medium transporting and reading apparatus comprising:
a reading member that has a reading portion for reading an image;
a first transport-path forming member that faces the reading member and has a first surface which forms a transport path portion for a recording medium together with the reading member;
a second transport-path forming member that forms transport path portions on the same side as the first transport-path forming member and has a second surface which forms the transport path portion on the upstream side of the first transport-path forming member in a recording-medium transport direction and a third surface which forms the transport path portion on the downstream side of the first transport-path forming member in the recording-medium transport direction;
an urging member that urges the first transport-path forming member toward the reading member in such a manner that the first transport-path forming member is movable relative to the second transport-path forming member; and
a restricting portion that restricts the movement of the first transport-path forming member so that a predetermined distance is maintained between the reading member and the first transport-path forming member.

2. The recording-medium transporting and reading apparatus according to claim 1, wherein the reading member includes a first guide member that projects to the upstream side of the reading member in the recording-medium transport direction and guides a leading end, in the recording-medium transport direction, of the recording medium toward the first surface as the leading end advances from the projecting end.

3. The recording-medium transporting and reading apparatus according to claim 1, wherein the reading member includes a second guide member that projects to the downstream side of the reading member in the recording-medium transport direction and guides the leading end, in the recording-medium transport direction, of the recording medium toward the third surface as the leading end advances to the projecting end.

4. The recording-medium transporting and reading apparatus according to claim 2, wherein the reading member includes a second guide member that projects to the downstream side of the reading member in the recording-medium transport direction and guides the leading end, in the recording-medium transport direction, of the recording medium toward the third surface as the leading end advances to the projecting end.

5. The recording-medium transporting and reading apparatus according to claim 2, wherein the distance between the second surface and a surface of an upstream end, in the recording-medium transport direction, of the first guide member, the surface facing the second surface, is larger than the distance between the first surface and a portion of a surface of the reading member, the portion being located on the upstream side, in the recording-medium transport direction, of a reading position, where an image on the recording medium is read, and facing the first surface.

6. The recording-medium transporting and reading apparatus according to claim 3, wherein the distance between the third surface and a surface of a downstream end, in the recording-medium transport direction, of the second guide member, the surface facing the third surface, is larger than the distance between the first surface and a portion of a surface of the reading member, the portion being located on the downstream side, in the recording-medium transport direction, of a reading position, where an image on the recording medium is read, and facing the first surface.

7. The recording-medium transporting and reading apparatus according to claim 4, wherein the distance between the third surface and a surface of a downstream end, in the recording-medium transport direction, of the second guide member, the surface facing the third surface, is larger than the distance between the first surface and a portion of a surface of the reading member, the portion being located on the downstream side, in the recording-medium transport direction, of a reading position, where an image on the recording medium is read, and facing the first surface.

8. The recording-medium transporting and reading apparatus according to claim 1, wherein the distance between the first surface and the surface of the reading member facing the first surface increases from the upstream side to the downstream side, in the recording-medium transport direction, of the reading position, where an image on the recording medium is read.

9. The recording-medium transporting and reading apparatus according to claim 1, wherein the transport path portions located on the upstream side in the recording-medium transport direction have smaller areas than those located on the downstream side at their boundaries.

10. The recording-medium transporting and reading apparatus according to claim 1, wherein the second transport-path forming member is movable relative to the reading member so that the transport path may be opened and closed.

11. A recording-medium transporting and reading apparatus comprising:
a first reading unit that reads a front surface of a recording medium; and
a second reading unit that reads a back surface of the recording medium, the second reading unit including:
a reading member that has a reading portion for reading an image;
a first transport-path forming member that faces the reading member and has a first surface which forms a transport path portion for a recording medium together with the reading member;
a second transport-path forming member that forms transport path portions on the same side as the first transport-path forming member and has a second surface which forms the transport path portion on the upstream side of the first transport-path forming member in a recording-medium transport direction and a third surface which forms the transport path portion on the downstream side of the first transport-path forming member in the recording-medium transport direction;
an urging member that urges the first transport-path forming member toward the reading member in such a manner that the first transport-path forming member is movable relative to the second transport-path forming member; and
a restricting portion that restricts the movement of the first transport-path forming member so that a predetermined distance is maintained between the reading member and the first transport-path forming member.
